(19) United States
(12) Patent Application Publication
(10) Pub. No.: US 2016/0182290 A1
(43) Pub. Date: Jun. 23, 2016

(54) METHOD FOR UPDATING A VIRTUAL PRIVATE NETWORK IN A MULTI-PROTOCOL LABEL SWITCHING NETWORK

(71) Applicant: AT&T Intellectual Property I, L.P., Atlanta, GA (US)

(72) Inventors: Mark Elias, Eastpointe, MI (US); Sherry Soja-Molloy, Taylor, MI (US)

(21) Appl. No.: 15/055,299

(22) Filed: Feb. 26, 2016

Related U.S. Application Data
(63) Continuation of application No. 11/379,465, filed on Apr. 20, 2006, now abandoned.

(51) Int. Cl. H04L 12/24; H04L 12/715; H04L 12/46; H04L 12/723

(52) U.S. Cl. CPC H04L 41/0806; H04L 45/50; H04L 45/04; H04L 12/4683; H04L 41/082

(57) ABSTRACT

A system and method are disclosed for updating a virtual private network (VPN) in a multi-protocol label switching (MPLS) network. A system that incorporates teachings of the present disclosure may include, for example, a network management system (NMS) having a controller that manages a communications interface coupled to an MPLS network. The controller can be programmed to generate one or more messages conforming to a border gateway protocol (BGP) for updating a VPN operating in the MPLS network.

This application is a continuation of U.S. patent application Ser. No. 11/379,465, filed Apr. 20, 2006, which is currently pending and is herein incorporated by reference in its entirety.

### FIELD OF THE DISCLOSURE

The present disclosure relates generally to multi-protocol label switching (MPLS) networks, and more specifically to a method for updating a virtual private network (VPN) in an MPLS network.

### BACKGROUND

In a multi-protocol label switching (MPLS) network configuring routers in a virtual private network (VPN) with an update to the VPN can be slow and prone to error under a centralized control system.

A need therefore arises for a method to update a VPN in an MPLS network.

### BRIEF DESCRIPTION OF THE DRAWINGS

FIG. 1 is a block diagram of a communication system;

FIG. 2 depicts a flowchart of a method for managing updates in a virtual private network (VPN) in a multi-protocol label switching (MPLS) network of the communication system; and

FIG. 3 is a diagrammatic representation of a machine in the form of a computer system within which a set of instructions, when executed, may cause the machine to perform any one or more of the methodologies discussed herein.

### DETAILED DESCRIPTION

Embodiments in accordance with the present disclosure provide a method for updating a virtual private network (VPN) in a multi-protocol label switching (MPLS) network.

In a first embodiment of the present disclosure, a network management system (NMS) can have a controller that manages a communications interface coupled to a multi-protocol label switching (MPLS) network. The controller can be programmed to generate one or more messages conforming to a border gateway protocol (BGP) for updating a virtual private network (VPN) operating in the MPLS network.

In a second embodiment of the present disclosure, a computer-readable storage medium in a router of a multi-protocol label switching (MPLS) network, comprising computer instructions for updating a virtual private network (VPN) operating in the MPLS network according to one or more received messages conforming to a border gateway protocol (BGP).

In a third embodiment of the present disclosure, a method can update a virtual private network (VPN) operating in a multi-protocol label switching (MPLS) network by submitting to a router of the VPN one or more messages conforming to a border gateway protocol (BGP).

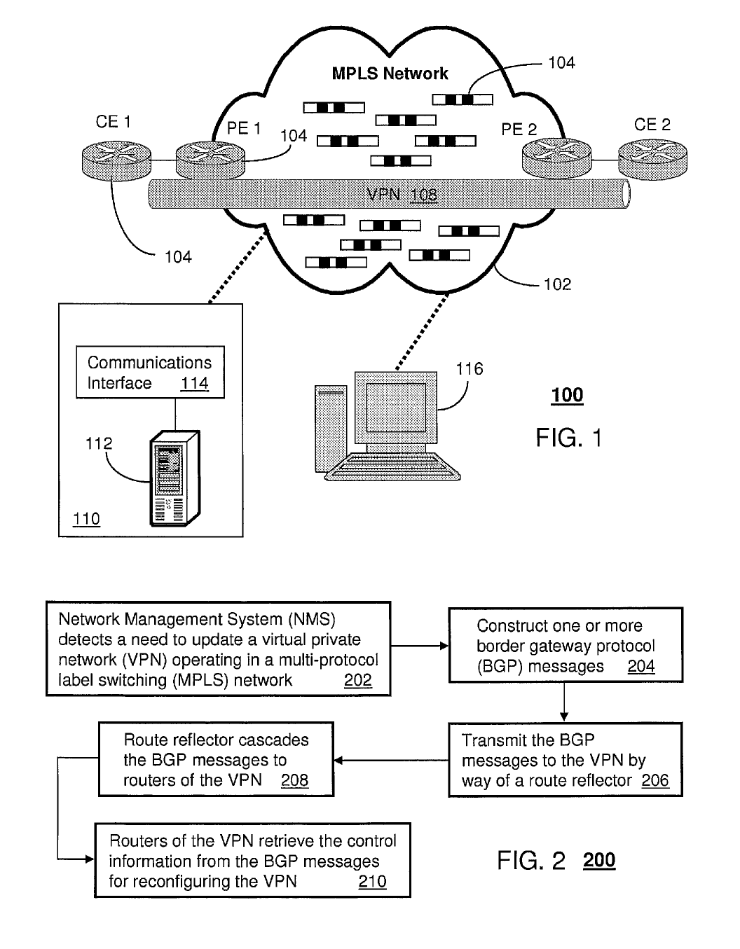

FIG. 1 is a block diagram of a communication system 100. The communication system 100 comprises a multi-protocol label switching (MPLS) network 102 having one or more routers 104 for establishing a virtual private network (VPN) 108. The routers 104 can have several embodiments such as a common provider edge (PE) router coupled to one or more common customer edge (CE) routers, and intermediate routers scattered throughout the MPLS network 102 for routing end-to-end VPN traffic according to the MPLS protocol. AVPN 108 between CE 1 and CE 2 can be established by a network management system (NMS) 110, thereby extending customer communication networks located in disparate geographic regions.

The NMS 110 comprises a common controller such as a desktop computer or scalable server that communicates to the MPLS network 102 by way of a communications interface 114 supporting common communication protocols such as TCP/IP. The NMS 110 can be programmed to provision a number of routers 104 of the MPLS network 102 to update the VPN 108 as needed according to the present disclosure. Alternatively, a common computing device 116 such as a desktop computer can be utilized for direct programming of a router 104. For obvious reasons, this latter embodiment provides a slower means for programming a number of routers 104 of the VPN 108.

FIG. 2 depicts a flowchart of a method 200 for managing updates to the VPN 108 in the MPLS network 102 of the communication system 100. Method 200 begins with step 202 in which the NMS 110 detects a need to update the VPN 108. The detection can be prompted by, for example, a customer relations management (CRM) system coupled to the NMS (not shown) that tracks customer network subscriptions and updates made thereto. Upon detecting an update, the NMS 110 can be programmed to construct one or more messages conforming to the border gateway protocol (BGP). BGP is a dynamic routing protocol that can be utilized by the MPLS network 102 to exchange routing information between the routers 104.

BGP can also be utilized for distributing provisioning information in the form of control information to a number of routers in the VPN 108 in accordance with the present disclosure. The control information can be included in one or more extensions of a BGP packet. BGP extensions are described in a request for comments (RFC) 4360 documentation disclosed by the Internet Engineering Task Force (IETF), which is incorporated herein by reference in its entirety. The NMS 110 can be programmed to utilize extended community attributes of BGP packets as described in RFC 4364 (incorporated herein by reference in its entirety) to insert control information for updating the VPN 108.

The control information can be structured according to a type-length-value (TLV) format. In other words, a type (or tag) can be assigned to describe a particular attribute such as a route distinguisher, the length can describe the number of bytes following the tag, and the value can be a number of TLV's for carrying control information to the router 104 to configure itself according to the updated requested for the VPN 108. The control information can comprise any number of configurable parameters including, but not limited to, a change in the number of routes allocated to the router 104 operating in the VPN 108, a change to the IP addresses managed by the router, a modification of a particular route in the VPN, or a merging of the VPN to another VPN in the MPLS network 102.

Once the BGP messages have been constructed, the NMS 110 can be programmed to transmit in step 206 said BGP messages to the VPN 108 by way of a route reflector (not shown) of the MPLS network 102 which in step 208 cascades the BGP messages to the routers 104 of the VPN. The routers 104 in turn retrieve the control information from the BGP message and reconfigure themselves in accordance with the update to be performed on the VPN 108.

Method 200 can have numerous embodiments not described by FIG. 2. For example, instead of a centralized management system such as the NMS 110, method 200 can be applied to a point-to-point configuration in which computing device 116 submits similar BGP messages to a single router 104 of the VPN 108 for reconfiguration thereof. Since BGP messages are cascaded by a route reflector or the router 104 itself, the VPN 108 can be updated with a single transmission of control information. It would be evident to an artisan with ordinary skill in the art that the aforementioned embodiments of method 200 can be further modified, reduced, or enhanced without departing from the scope and spirit of the claims described below. The reader is therefore directed to the claims for a fuller understanding of the breadth and scope of the present disclosure.

It should be noted that the foregoing embodiments of method 200 overcome the deficiencies in prior art systems that update a VPN one router at a time from a centralized system. The present disclosure teaches a method in which control information can be cascaded among routers 104 with BGP messages transmitted only once from the NMS 110 or a common computing device 116. The present disclosure therefore minimizes the potential for error, and is more efficient in its distribution of provisioning data amongst the routers 104.

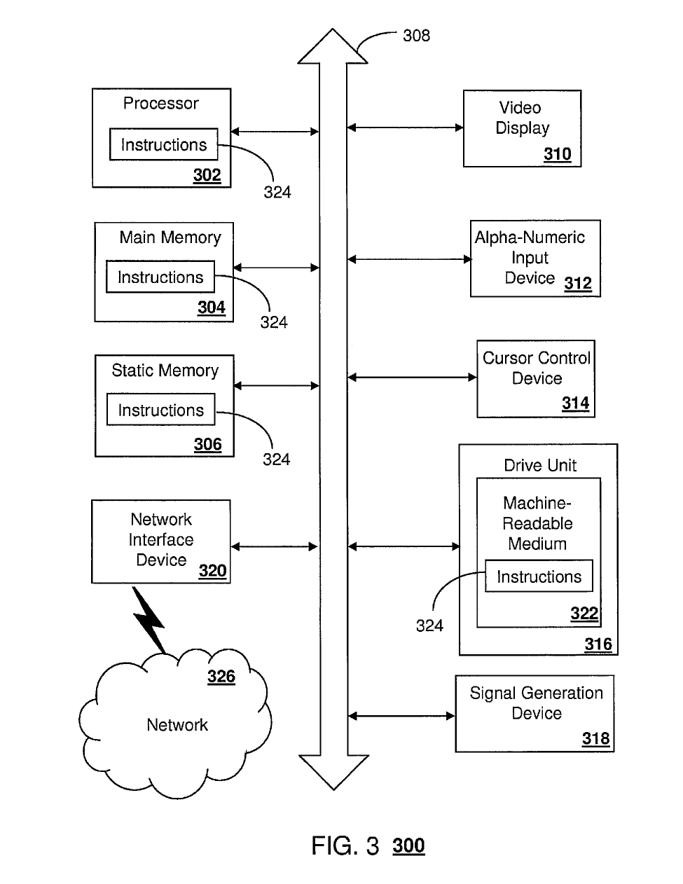

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a processor; and
a computer-readable storage medium storing instructions which, when executed by the processor, cause the processor to perform operations, the operations comprising:
detecting an update of a customer network subscription to a virtual private network operating in a multi-protocol label switching network, the update being prompted by a customer relations management system tracking the customer network subscription;
generating a border gateway protocol message containing provisioning information to provision the virtual private network based on the update; and
transmitting the border gateway protocol message to a route reflector in the multi-protocol label switching network to propagate the border gateway protocol message to a subset of a plurality of routers of the multi-protocol label switching network to cause the virtual private network to be provisioned.

2. The apparatus of claim 1, wherein the provisioning information is included in one or more extensions of the border gateway protocol message.

3. The apparatus of claim 1, wherein the provisioning information is in a type-length-value format.

4. The apparatus of claim 3, wherein the type-length-value format comprises a type that describes an attribute of a route of the virtual private network.

5. The apparatus of claim 4, wherein the type-length-value format further comprises a length that describes a number of bytes following the type.

6. The apparatus of claim 5, wherein the type-length-value format further comprises a value for carrying control information.

7. The apparatus of claim 6, wherein the control information is for changing a number of routes allocated to a router of the subset of the plurality of routers operating in the virtual private network.

8. The apparatus of claim 6, wherein the control information is for changing an internet protocol address managed by a router of the subset of the plurality of routers operating in the virtual private network.

9. The apparatus of claim 6, wherein the control information is for modifying a route of the virtual private network.

10. The apparatus of claim 6, wherein the control information is for merging the virtual private network to another virtual private network in the multi-protocol label switching network.

11. The apparatus of claim 6, wherein the control information is for reconfiguring the virtual private network in one or more extended community attributes of the border gateway protocol message.

12. A method comprising:
detecting, by a processor, an update of a customer network subscription to a virtual private network operating in a multi-protocol label switching network, the update being prompted by a customer relations management system tracking the customer network subscription;
generating, by the processor, a border gateway protocol message containing provisioning information to provision the virtual private network based on the update; and
transmitting, by the processor, the border gateway protocol message to a route reflector in the multi-protocol label switching network to propagate the border gateway protocol message to a subset of a plurality of routers of the multi-protocol label switching network to cause the virtual private network to be provisioned.

13. The method of claim 12, wherein the provisioning information is included in one or more extensions of the border gateway protocol message.

14. The method of claim 12, wherein the provisioning information is in a type-length-value format.

15. The method of claim 14, wherein the type-length-value format comprises a type that describes an attribute of a route of the virtual private network, a length that describes a number of bytes following the type, and a value for carrying control information.

16. The method of claim 15, wherein the control information is for changing a number of routes allocated to a router of the subset of the plurality of routers operating in the virtual private network.

17. The method of claim 15, wherein the control information is for changing an internet protocol address managed by a router of the subset of the plurality of routers operating in the virtual private network.

18. The method of claim 15, wherein the control information is for modifying a route of the virtual private network.

19. A tangible computer-readable storage medium storing a plurality of instructions which, when executed by a processor, cause the processor to perform operations, the operations comprising:
detecting an update of a customer network subscription to a virtual private network operating in a multi-protocol label switching network, the update being prompted by a customer relations management system tracking the customer network subscription;
generating a border gateway protocol message containing provisioning information to provision the virtual private network based on the update; and
transmitting the border gateway protocol message to a route reflector in the multi-protocol label switching network to propagate the border gateway protocol message to a subset of a plurality of routers of the multi-protocol label switching network to cause the virtual private network to be provisioned.

20. The tangible computer-readable storage medium of claim 19, wherein the provisioning information is included in one or more extensions of the border gateway protocol message.
